(19) United States
(12) Patent Application Publication
(10) Pub. No.: US 2002/0065883 A1
(43) Pub. Date: May 30, 2002

(54) Method and apparatus for effecting a personal profile detection system

(76) Inventors: E. Michael Lunsford, San Carlos, CA (US); Steve Parker, Centerville, UT (US); David Kammer, Seattle, WA (US); David Moore, Riverton, UT (US)

Correspondence Address: WAGNER, MURABITO & HAO LLP, Two North Market Street, Third Floor, San Jose, CA, 95113, US

(21) Appl. No.: 09/727,986

(22) Filed: Nov. 30, 2000

(51) Int. Cl. G06F 15/16

(52) U.S. Cl. 709/204; 709/217

(57) ABSTRACT

The invention disclosed is a method and apparatus for effecting a personal profile detection system upon handheld organizers, portable information devices (PID's), and other computing devices. The method first provides for the accepting and then storing of personal profile data on a PID and allows for the profile data to be fully customizable by the user. The method then provides for an exchange of information between the first PID and a proximate second PID via short-range RF (Radio Frequency) communications when shared interests exist between the profile data stored on the two PID's. In one embodiment, the exchange of information is user customizable and based upon a determination of shared interests by the first PID in a manner that is also user customizable. The method further provides for the initiation of an event such as the sounding of an alarm and the display of received information.

### FIELD OF THE INVENTION

The present invention relates to wireless communications. More particularly, the present invention pertains to a method and apparatus for effecting a personal profile detection system upon handheld organizers, portable information devices (PID's), and other computing devices.

### BACKGROUND OF THE INVENTION

People are often in the presence of others with whom they have shared interests without realizing that they have those shared interests. In business life for example, sales personnel attending a large trade show may walk right by a group of buyers who would love to hear all about the products that the sales people have to promote, but if the two groups aren't aware of their shared interests, they may never make a connection. Or for example, a company manager attending a technical conference may be in the presence of a superbly skill-matched prospective employee but never become aware of the nearby presence of that prospective employee and her skills.

Shared personal interests among individuals also commonly go unrecognized. People passing one another on the street or in shops or at clubs commonly have shared interests but they often do not have a means for learning of those shared interests. Convenient commute partners go unrecognized, well-matched sports partners are passed by, and dating opportunities are lost. A means and method to create an awareness in an individual of the proximity of other individuals with shared interests would be of great personal and economic value to individuals and organizations in general.

The use and presence of handheld organizers and other such compact and lightweight portable information devices (PID's), including PDA's (personal digital assistants), laptop computers, desktop computers, servers, pagers, cellular phones, modems, other peripheral devices and other personal electronic devices comprising gaming devices, digital cameras, mobile access devices, digital camcorders and mp3/walkman players, has burgeoned in recent years. The availability of these items to the average consumer has placed millions into use and into all aspects of one's business life and daily life. The presence of these devices has become common in the home and office, on the streets, in shops and restaurants, and in places of travel. The development of new devices and the creation of hybrids of previously existing devices will undoubtedly cause their numbers and prevalence to continue to grow.

Recently various wireless communications protocols, such as the Bluetooth, WAP (Wireless Application Protocol), Home RF (Home Radio Frequency), HiperLAN (Hiper Local Area Network), I.E.E.E. (Institute of Electrical and Electronics Engineers) 802.11a and 802.11b protocols, have been developed to provide standardized methods for establishing low-to-medium power, short-to-intermediate range radio frequency (RF) communications between RF enabled devices.

The incorporation of these protocols and short-range RF communications ability with various electronic devices is just beginning to be explored. The direct and intended beaming of signals and information between portable communications devices is common, such as with cellular phone communications and the wireless access of PID's to the Internet. However, the beneficial sharing of information between the handheld organizers of random passers-by having unknown shared interests has heretofore not been pursued or accomplished.

There is a need for a method and apparatus whereby a user of a handheld organizer, PID, or other computing device can be made aware of the proximity of other individuals or organizations having shared interests with the user and for the user to be able to exchange personal information and data relevant to those interests with those other users. The invention described herein provides for such a method and apparatus.

### SUMMARY OF THE INVENTION

Accordingly, the invention disclosed is a method and apparatus whereby a user of a handheld organizer, PID, or other computing device is made aware of the proximity of other individuals or organizations having shared interests with the user. The invention effects a personal profile detection (PPD) system upon handheld organizers and other portable information devices (PID's). The invention allows the user to exchange personal and business information and data relevant to shared interests with others proximate to the user. The invention may also be implemented on various stationary computing devices such as desktop computers and servers.

In one embodiment of the invention as a method, the method first provides for the accepting and then storing of personal profile data on a PID and allows for the profile data to be fully customizable by the user. The method then provides for an exchange of information between the first PID and a proximate second PID when shared interests exist between the profile data stored on the two PID's. In a related embodiment, the exchange of information is user customizable and based upon a determination of shared interests by the first PID in a manner that is also user customizable.

In another embodiment, the determination of shared interests existing between the first PID and a second PID is performed via short-range RF (Radio Frequency) communications between the PID's where the first PID searches for and detects profile data keyword information transmitted from a second PID. The first PID then determines what shared interests exist, requests relevant data regarding those interests from the second PID, and receives the data as provided by the second PID. The method further provides for the initiation of an event such as the sounding of an alarm and the display of received information. Various wireless communications protocols are employed in other embodiments, including the Bluetooth, WAP (Wireless Application Protocol), Home RF (Home Radio Frequency), HiperLAN (Hiper Local Area Network), Ultra Wide-Band, I.E.E.E. (Institute of Electrical and Electronics Engineers) 802.11a and 802.11b protocols.

In an embodiment of the invention as an apparatus, the components of a handheld organizer or other PID are appropriately augmented with computing and RF communications ability to effect a personal profile detection system. The resulting apparatus comprises a data input component coupled to a means for accepting customizable profile data input by a user from the data input component. The means is further coupled to a storage component for storing the customizable profile data. The embodiment is further comprised of a RF communications receiver coupled to the means for accepting customizable profile data, the receiver providing for the receipt of profile information from a proximate PID or other device. A transmitter may also be added in another embodiment so to enable the invention to provide two-way sharing of profile data. A means for the customizable determination of shared interests may also be incorporated in another embodiment.

### BRIEF DESCRIPTION OF THE DRAWINGS

The operation of this invention can be best visualized by reference to the following drawings described below.

FIG. 1 illustrates an exemplary portable information device (PID) upon which the personal profile detection system may be practiced in accordance with an embodiment of the invention.

FIG. 2 is a block diagram depicting a method for effecting a personal profile detection system upon a PID in accordance with an embodiment of the invention.

FIG. 3 is a block diagram depicting a further method for effecting a personal profile detection system upon a PID in accordance with an embodiment of the invention.

FIG. 4 is a block diagram depicting a further method for effecting a personal profile detection system upon a PID in accordance with an embodiment of the invention.

FIG. 5 is a block diagram depicting a method for effecting a personal profile detection system upon a PID where RF communications ability enablement is a precursor to the embodiment depicted in FIG. 2, in accordance with an embodiment of the invention.

### DETAILED DESCRIPTION OF THE PREFERRED EMBODIMENTS

Described in detail below is a method and apparatus for effecting a personal profile detection system, and the invention is particularly well adapted to handheld organizers and other types of portable information devices. In the following description, for purposes of explanation, numerous specific details are set forth in order to provide a thorough understanding of the present invention. It will be obvious, however, to one skilled in the art that the present invention may be practiced without these specific details. In other instances, well-known structures and devices are shown in block diagram form in order to avoid obscuring the present invention.

The invention disclosed in one embodiment is an apparatus that serves as a personal profile detection system. The apparatus incorporates components of a handheld organizer or other type of PID and adds additional components and means to effect the personal profile detection system. The invention may also be effected upon stationary computers, such as desktop computers and servers, PDA's (personal digital assistants), laptop computers, pagers, cellular phones, modems, other peripheral devices and other personal electronic devices comprising gaming devices, digital cameras, mobile access devices, digital camcorders and mp3/walkman players. The resulting apparatus allows a user to be made aware of the proximity of other individuals or organizations having shared interests with the user. The invention allows the user to exchange personal and business information and data relevant to shared interests with others proximate to the user.

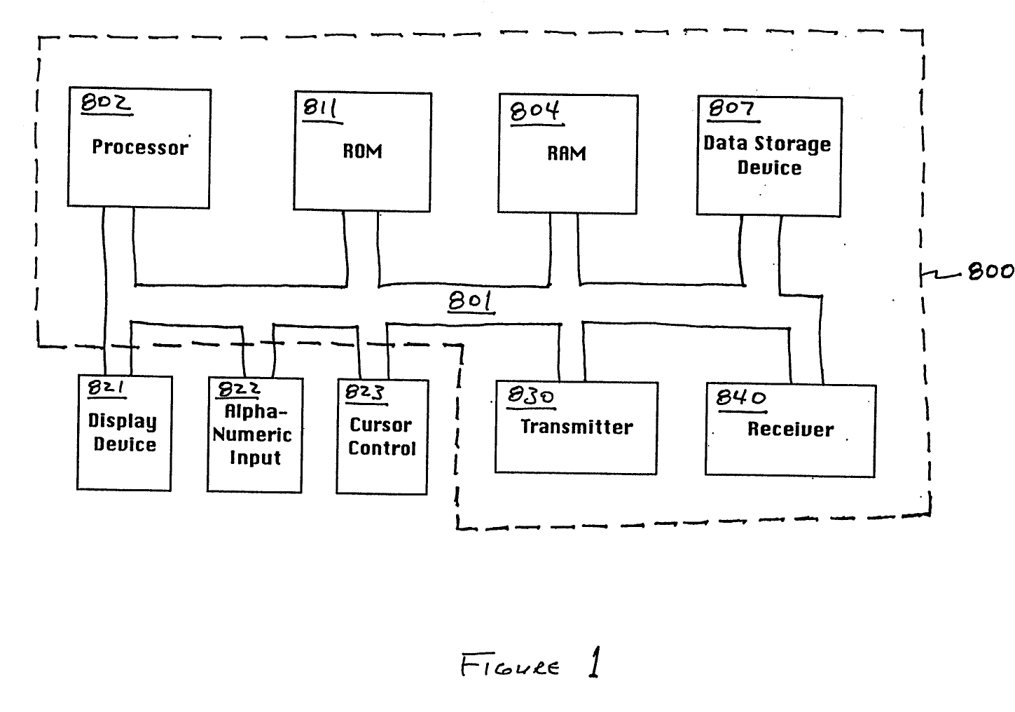

FIG. 1 illustrates an exemplary configuration of a portable information device (PID) 800 upon which the present invention may be implemented or practiced. It is appreciated that the PID 800 of FIG. 1 is exemplary only and that the present invention can operate upon a number of different information devices and computer systems, portable and stationary. PID 800 of FIG. 1 includes an address/data bus 801 for conveying digital information between the various components, a central processor unit (CPU) 802 for processing the digital information and instructions, a main memory 804 comprised of random access memory (RAM) for storing the digital information and instructions, a read only memory (ROM) 811 for storing information and instructions of a more permanent nature. In addition, PID 800 may include a data storage device 807 (e.g., a magnetic, optical, floppy, or tape drive). A transmitter 830 and a receiver 840 are additionally included within the PID 800 shown. It should be noted that the client program for performing the functions of the invention can be stored either in main memory 804, data storage device 807, or in an external storage device. Devices which may be coupled to PID 800 include a display device 821 for displaying information to a PID user, an alphanumeric input device 822 (e.g., a keyboard), and a cursor control device 823 (e.g., mouse, trackball, light pen, etc.) for inputting data and selections.

In another embodiment, the invention is comprised of a device having a data input component coupled to a means for accepting customizable data input by a user from the data input component where the means allows for accepting user customizable profile data. The means is further coupled to a storage component for storing the customizable profile data. The embodiment is further comprised of a RF communications receiver coupled to the means for accepting customizable profile data, the receiver providing for the receipt of profile information from a proximate PID or other device. A transmitter may also be added in another embodiment so to enable the invention to provide two-way sharing of profile data.

In another embodiment of the invention, a computer-usable medium, such as ROM 811, RAM 811, and/or data storage device 807 of FIG. 1, has stored thereon computer-readable code for causing a computer, such as processor 802 of FIG. 1, or portable information device, e.g. PID 800 described in FIG. 1, to effect a personal profile detection system upon such a device. The code enables the device to act as a personal profile detection system.

In an embodiment of the invention the components of PID 800 of FIG. 1 are resident within a device, such as a handheld organizer, for which personal profile detection is desired, and the computer-readable code described above is downloaded to a computer-usable medium within the device so to allow it to respond as a PPD device.

In another embodiment of the invention, a device such as PID 800 has the computer-readable code described above stored on a computer-usable medium within the device a priori, and then this device is attached to a second device, such as a cellular phone, for which personal profile detection is desired.

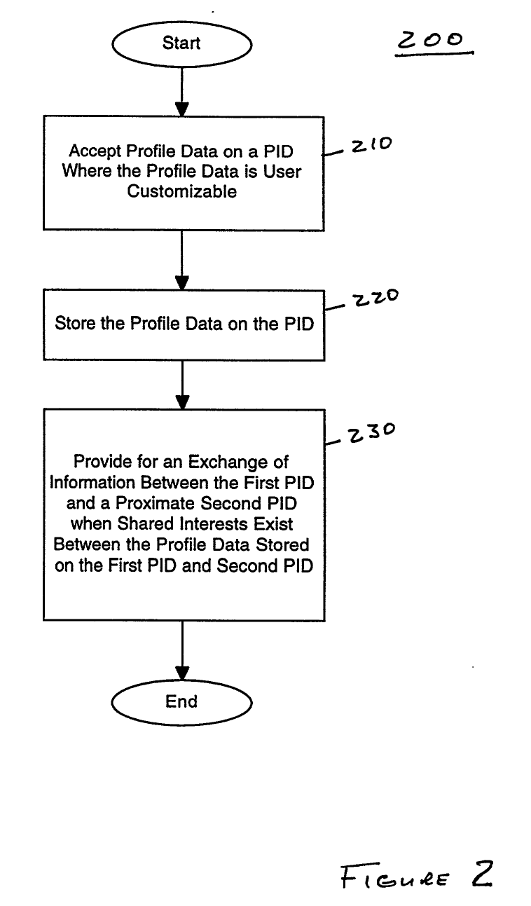

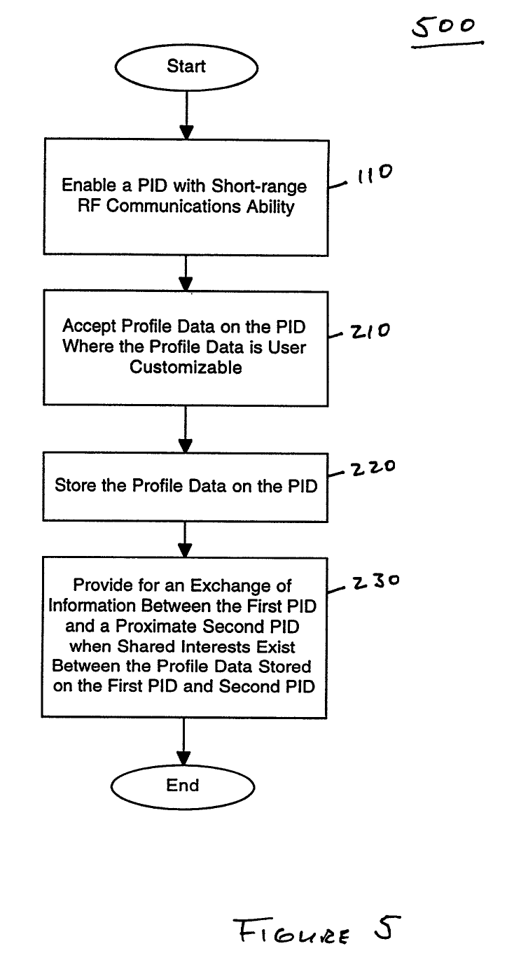

Various embodiments of the invention as a method for effecting a personal profile detection system upon handheld organizers and other computing devices are shown in FIGS. 2-5. In the embodiments referencing FIGS. 2-4, RF communications ability is pre-existing in the device. In FIG. 5, an embodiment is depicted where the step of enablement of a device with RF communications ability is incorporated into the method for effecting the personal profile detection system upon the device.

In FIG. 2 method 200 begins with the step 210 where user customizable profile data is accepted by a PID. The profile data may be of any criteria or subject matter that the user wishes. The profile data may be entered in modules or sections such that portions may be shared while other portions are not. Keyword information may be entered corresponding to the various criteria or interests for which profile data is provided.

In step 220 of the method 200, the profile data is stored on the PID. The various modes and components of storage common to computing devices and PID's may be employed, including volatile memory, non-volatile memory, solid-state memory, mass storage and other types of storage.

In step 230 of FIG. 2, the embodiment of the invention provides for an exchange of information between the first PID held by the user and a proximate second PID when shared interests exist corresponding to the profile data stored on the first PID and the profile data resident on the proximate second PID. In another embodiment, the step 230 of provision for an exchange of information may also be user customizable. Additional embodiments described below further elaborate upon variations in this step.

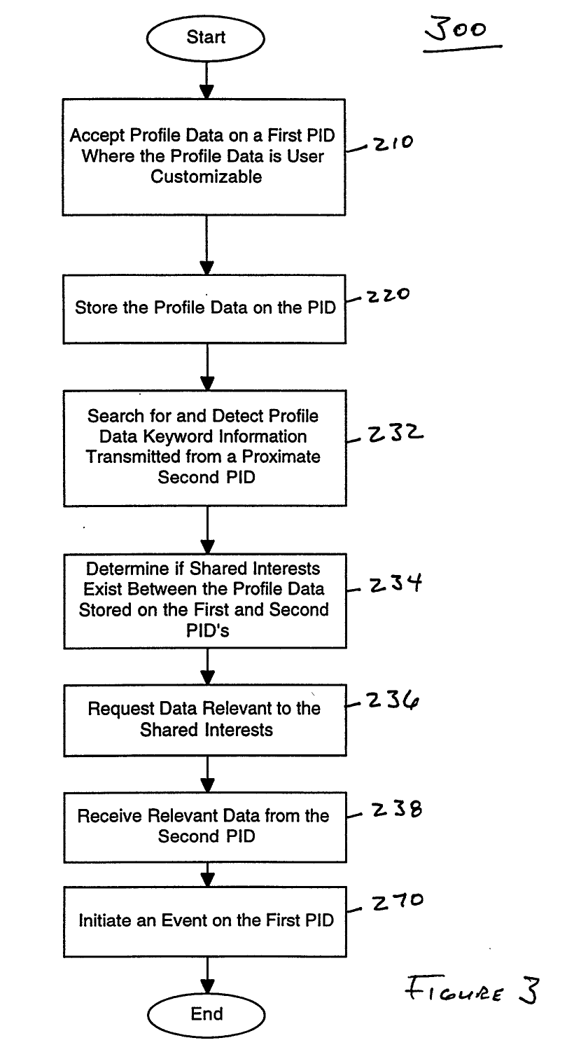

In FIG. 3 another embodiment of the invention as a method for effecting a personal profile detection system upon a PID is depicted in flow diagram form. The method 300 begins with the step 210, accepting profile data on a first PID, as described previously in method 200 of FIG. 2. Step 220 of method 200, storing the profile data on the first PID, is also performed in method 300 of FIG. 3.

Following step 220, step 232 of FIG. 3, provides for the search and detection of profile data keyword information transmitted from a proximate second PID. This step may incorporate any of various RF communication and detection schemes and protocols, including the Bluetooth, WAP (Wireless Application Protocol), Home RF (Home Radio Frequency), HiperLAN (Hiper Local Area Network), Ultra Wide-Band, and I.E.E.E. (Institute of Electrical and Electronics Engineers) 802.11a and 802.11b protocols.

Step 234 then provides for the first PID to determine if shared interests exist between the profile data stored on that PID and the profile data stored on the proximate second PID. The determination of shared interests by the PID may also be user customized, as is described in further embodiments.

Step 236 of FIG. 3 provides for the request of data from the proximate second PID that is relevant to the interests determined to be of a shared nature in step 234. Step 238 then provides for the receipt of the requested shared data. The request and receipt steps 236 and 238 may also incorporate any of various RF communication and detection schemes and protocols, including the Bluetooth, WAP, and I.E.E.E. 802.11 protocols.

The method 300 of FIG. 3 finishes with step 270, the initiation of an event on the first PID. The event may include the sounding of an alarm, the display of received data, the transmittal of data, and other events. In a further embodiment, an event is initiated on the proximate second PID as well as the first PID.

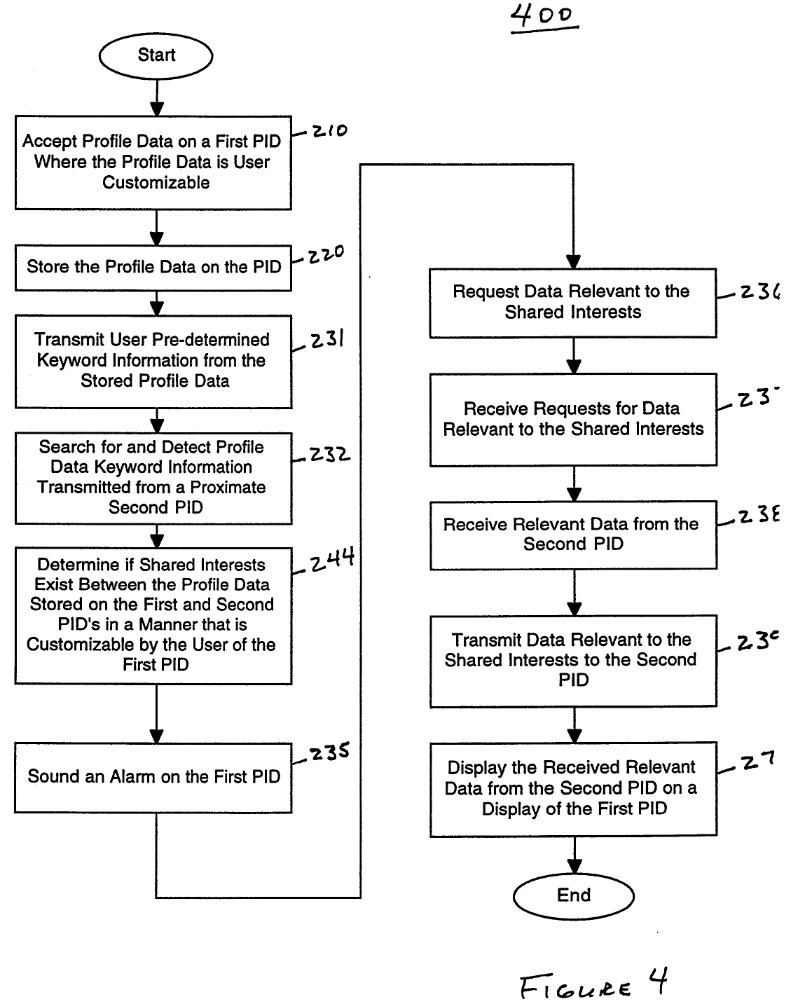

The embodiment of the invention depicted in FIG. 4 includes all those aspects of the embodiments depicted in FIG. 2 and 3 and adds further functionality.

In FIG. 4, method 400 begins with step 210, the acceptance of profile data on a first PID where the profile data is user customizable, and then proceeds with the storing of the data on the PID in step 220.

Step 231 follows and provides for the transmittal of user pre-determined keyword information from the stored profile data. This step may also provide for the transmittal to incorporate any of various RF communication protocols, including the Bluetooth, WAP (Wireless Application Protocol), Home RF (Home Radio Frequency), HiperLAN (Hiper Local Area Network), Ultra Wide-Band, and I.E.E.E. (Institute of Electrical and Electronics Engineers) 802.11a and 802.11b protocols.

Step 232 in FIG. 4 is then performed as in method 300 of FIG. 3, where profile data keyword information from a proximate second PID is searched for and detected by the first PID.

In step 244 of FIG. 4, the first PID determines if shared interests exist corresponding to the profile data stored in the first PID and the profile data stored in the proximate second PID, and in this step the manner of determination of shared interests is customizable by the user of the first PID. In example, the determination may be based on matches of keywords from the profile data of the first and second PID's, or by the existence of minimum or maximum criteria gleaned from a summary of the profile data transmitted by the second PID. Other techniques for determining the existence of shared interests may be employed as desired by the user.

Method 400 then continues with step 235 where an alarm is sounded on the first PID when shared interests have been determined to exist with a proximate second PID. The alarm signal may also be communicated to the proximate second PID to inform it of a determination of the existence of shared interests.

Step 236 follows in method 400 of FIG. 4 as in method 300 of FIG. 3 where the first PID requests from the proximate second PID further data relevant to the shared interests.

In step 237, the method 400 of FIG. 4 continues with the first PID receiving a request for further data relevant to shared interests from the profile data stored on the first PID. The receipt of requests for data may incorporate any of various RF communication protocols, including the Bluetooth, WAP (Wireless Application Protocol), Home RF (Home Radio Frequency), HiperLAN (Hiper Local Area Network), Ultra Wide-Band, and I.E.E.E. (Institute of Electrical and Electronics Engineers) 802.11a and 802.11b protocols.

Method 400 continues with step 238 where the first PID receives from the proximate second PID the data relevant to shared interests and step 239 follows where the first PID transmits to the proximate second PID that data from the profile data of the first PID that is relevant to the shared interests. The data that is transmitted by the first PID is user customizable and can be made dependent upon the level of commonality of interests determined in step 244.

Method 400 then concludes with step 275 where the first PID displays the relevant data received from the proximate second PID.

FIG. 5 depicts an additional embodiment of the invention where the method 500 results by preceding method 200 of FIG. 2 by the step 110. In step 110 a PID is enabled with short-range RF communications ability. Steps 210,220, and 230, as described above in reference to FIG. 2, follow similarly and sequentially thereafter. The step 110 may be added at other points prior to the exchange of information step 230.

Similarly, additional embodiments of the method of the invention are obtained when step 110, enabling a PID with short-range RF communications ability, is added as a precursor step to both methods 300 of FIG. 3 and 400 of FIG. 4.

Hence, a method and apparatus for effecting a personal profile detection system is disclosed. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be pre-defined by the claims appended hereto and their equivalents.

What is claimed is:

1. A method for personal profile detection comprising the steps of:
a) accepting profile data on a first PID (Portable Information Device) wherein said profile data is customizable by a user of said PID;
b) storing said profile data on said first PID;
c) providing for an exchange of information between said first PID and a second PID proximate with said first PID when shared interests exist between said profile data stored on said first PID and profile data stored on said second PID.

2. The method of claim 1 wherein said step c) comprises providing for a user customizable exchange of information between said first PID and a second PID proximate with said first PID when shared interests exist between said profile data stored on said first PID and profile data stored on said second PID.

3. The method of claim 1 wherein said step c) further comprises the step of:
c1) determining by said first PID shared interests existing between said profile data stored on said first PID and profile data stored on said second PID.

4. The method of claim 3 wherein said step c1) comprises determining by said first PID shared interests existing between said profile data stored on said first PID and profile data stored on said second PID wherein said determining is user customizable.

5. The method of claim 1 wherein said step c) further comprises the steps of:
searching for and detecting by said first PID profile data keyword information transmitted from a second PID;
determining by said first PID shared interests existing between said profile data stored on said first PID and profile data stored on said second PID;
requesting by said first PID from said second PD data relevant to said shared interests; and
receiving said relevant data from said second PD by said first PID.

6. The method of claim 1 wherein said step c) further comprises the steps of:
transmitting by said first PID user predetermined keyword information from said stored profile data of said first PID;
receiving requests by said second PID for profile data relevant to said transmitted keyword information; and
transmitting said relevant profile data to said second PID.

7. The method of claim 1 further comprising the step of:
d) initiating an event on at least one of said first PID and said second PID when shared interests exist.

8. The method of claim 7 wherein said step d) further comprises the sounding of an alarm on said first PID.

9. The method of claim 7 wherein said step d) further comprises displaying relevant data from said second PID on a display of said first PID.

10. The method of claim 1 wherein said step c) of providing for an exchange of information comprises RF (Radio Frequency) communications which incorporate the Bluetooth protocol.

11. The method of claim 1 wherein said PID's comprise handheld organizers.

12. The method of claim 1 further comprising the step of:
b1) enabling said PID with short-range RF communications ability.

13. A personal profile detection (PPD) device comprising:
a) a data input component;
b) means for accepting customizable profile data input by a user from said data input component, said means for accepting customizable profile data coupled to said data input component;
c) a data storage component coupled to said means for accepting customizable profile data, said data storage component adapted to storing said customizable profile data; and
d) a RF communications receiver coupled to said means for accepting customizable profile data, said RF communications receiver adapted to receive information from a proximate portable information device (PID).

14. The PPD device of claim 13 wherein said means for accepting customizable profile data further provides for:
determining the existence of shared interests corresponding to said customizable profile data and profile data received from said proximate PID.

15. The PPD device of claim 13 further comprising:
e) a RF communications transmitter coupled to said means for accepting customizable profile data, said transmitter adapted to transmit information from said PPD device to said proximate PID when shared interests exist between said customizable profile data and profile data of said proximate PID.

16. The PPD device of claim 13 wherein said data storage component is selected from the group consisting of volatile memory, nonvolatile memory, solid-state memory, mass storage or other storage components.

17. The PPD device of claim 13 further comprising:
e) a display component coupled to said means for accepting customizable profile data and adapted to display said information received from said proximate PID.

18. The PPD device of claim 15 wherein said RF communications receiver and said means for accepting customizable profile data further adapted to:
search for and detect keyword information transmitted by said proximate PID, and
upon determination of said shared interests by said means for accepting customizable profile data, said transmitter and said means for accepting customizable profile data request from said proximate PID data relevant to said shared interests.

19. The PPD device of claim 14 further comprising:
e) a speaker coupled to said means for accepting customizable profile data and adapted to sound an alarm when said means for accepting customizable profile data determines said existence of said shared interests corresponding to said customizable profile data and said profile data received from said proximate PID.

20. The PPD device of claim 13 wherein said RF communications receiver is adapted to operate according to the Bluetooth protocol.

21. A computer-usable medium having computer-readable code embodied therein for causing a PID (Portable Information Device) to perform the steps of:
a) accepting profile data on a first PID (Portable Information Device) wherein said profile data is customizable by a user of said PID;
b) storing said profile data on said first PID;
c) providing for an exchange of information between said first PID and a second PID proximate with said first PID when shared interests exist between said profile data stored on said first PID and profile data stored on said second PID.

22. The computer-usable medium of claim 21 further comprising the step of:
d) initiating an event on said first PID when shared interests exist.

23. The computer-usable medium of claim 21 wherein said step c) further comprises the steps of:
searching for and detecting by said first PID profile data keyword information transmitted from a second PID;
determining by said first PID shared interests existing between said profile data stored on said first PID and profile data stored on said second PID;
requesting by said first PID from said second PID data relevant to said shared interests; and
receiving said relevant data from said second PID by said first PID.
